(19) United States
(12) Patent Application Publication
(10) Pub. No.: US 2004/0179111 A1
(43) Pub. Date: Sep. 16, 2004

(54) Imaging device

(75) Inventor: Yuko Hattori, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/737,822

(22) Filed: Dec. 18, 2003

(30) Foreign Application Priority Data
Jan. 7, 2003 (JP) 2003-001445

(51) Int. Cl. H04N 5/228

(52) U.S. Cl. 348/222.1

(57) ABSTRACT

The imaging device according to the present invention can alter characteristics of gradation conversion depending on a variety of subjects and thus perform optimum gradation conversion. To this end, the imaging device according to the present invention includes an imaging part which picks up a subject image via a photo-taking lens to generate image data, a gradation conversion part which performs gradation conversion of the image data generated by the imaging part, and an obtaining part which obtains subject information containing at least one of a focal length of the photo-taking lens and an object distance of the subject, in which the gradation conversion part alters the characteristic of the gradation conversion depending on the subject information obtained by the obtaining part when performing the gradation conversion.

### BACKGROUND OF THE INVENTION

1. Field of the Invention

The present invention relates to an imaging device having a function of performing gradation conversion of image data obtained by photographing.

2. Description of the Related Art

Conventionally, to perform gradation conversion of image data in accordance with a photographic subject, there has been developed an imaging device having a function of altering characteristics of gradation conversion depending on subject information. For example, Japanese Unexamined Patent Application Publication No. 2001-54014 discloses an imaging device in which the characteristics of gradation conversion are altered based on results of divisional photometry obtained from a divisional photometry sensor as subject information.

However, since the above-described imaging device alters the characteristics of gradation conversion exclusively depending on results of the divisional photometry, there has been a case where the characteristics of gradation conversion cannot be altered in accordance with a variety of subjects.

### SUMMARY OF THE INVENTION

It is an object of the present invention to provide an imaging device that is able to alter characteristics of gradation conversion in accordance with a variety of subjects and perform optimum gradation conversion.

To achieve the above-described object, the imaging device according to the present invention includes an imaging part which picks up a subject image via a photo-taking lens to generate image data, a gradation conversion part which performs gradation conversion of image data generated by the imaging part, and an obtaining part which obtains subject information containing at least one of a focal length of the photo-taking lens and an object distance of the subject. The gradation conversion part alters the characteristic of the gradation conversion depending on the subject information obtained by the obtaining part when performing the gradation conversion.

### BRIEF DESCRIPTION OF THE DRAWINGS

FIG. 1 is a functional block diagram showing a digital still camera;

FIG. 2 is a flow chart showing operations of a controlling unit;

FIG. 3 is a table for use in determination of tone curves; and

FIG. 4 is a graph representing tone curves.

### DESCRIPTION OF THE PREFERRED EMBODIMENT

Hereinafter, a preferred embodiment of the present invention will be described in detail with reference to the accompanying drawings, in which a digital still camera is used as an illustrative example of the imaging device of the present invention.

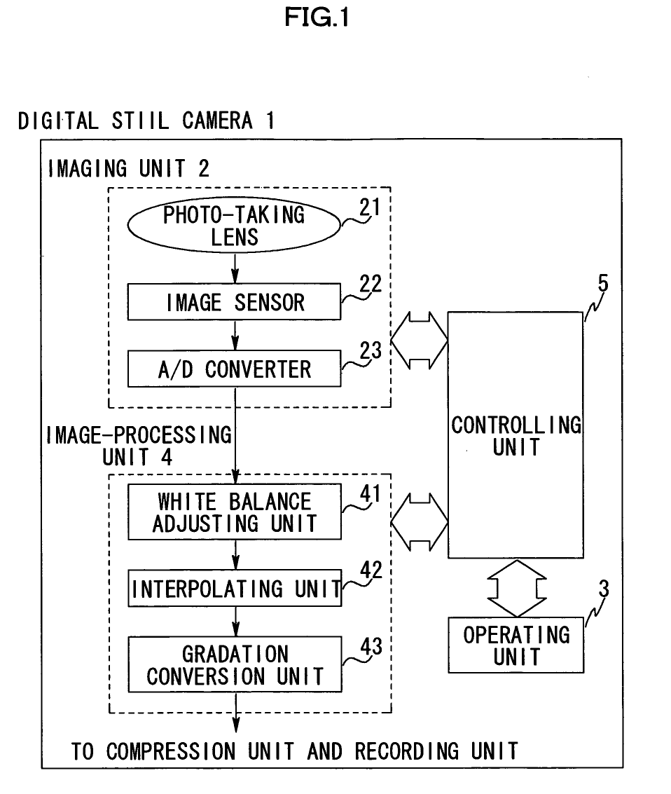

FIG. 1 is a functional block diagram showing a digital still camera in this embodiment.

In FIG. 1, the digital still camera 1 includes an imaging unit 2, an operating unit 3, an image-processing unit 4, and a controlling unit 5, in which the imaging unit 2, the operating unit 3, and the image-processing unit 5 are respectively connected to the controlling unit 5.

In the imaging unit 2, there are provided a photo-taking lens 21, an image sensor 22, and an A/D converter 23. A subject is picked up by the image sensor 22 via the photo-taking lens 21, and image signals obtained are converted into digital signals in the A/D converter 23 and then outputted to the image-processing unit 4. The digital signal output from the A/D converter 23 undergoes image-processing in the image-processing unit 4 (described later in detail), and the image data after undergoing image-processing is outputted to a compression unit and a recording unit (both not shown).

The operating unit 3 includes members adapted for accepting user operations, such as a release button, a zooming button to perform zooming operations described below, and a selecting button to select a continuous shooting mode described below. The user operations on the operating unit 3 are detected by the controlling unit 5.

The photo-taking lens 21 is a zooming lens adapted to continuously alter a focal length and includes a lens group movable to alter the focal length and a lens group movable for focusing (both not shown). Further, the photo-taking lens 21 includes an encoder (not shown) that recognizes the position of each of the lens groups described above, from which information indicative of the position of each of the lens groups is outputted to the controlling unit 5.

The controlling unit 5 performs a predetermined calculation based on the information obtained from the image sensor 22 or the like and provides instructions regarding adjustment of the focal length to the imaging unit 2. In the imaging unit 2, the lens group for focusing is caused to move under the instructions from the controlling unit 5. Further, the controlling unit 5 provides an instruction to the imaging unit 2 to perform a zooming operation in response to user operation on the controlling unit 3. Then in the imaging unit 2, the lens group for adjusting the focal length is caused to move under the instruction from the controlling unit 5.

There is pre-stored in a memory (not shown) in the controlling unit 5 a program showing the contents of operations of the respective unit. The program may be the one that is recorded in a recording medium, or the one that is downloaded as transmitted waves via Internet. The operations of each of the units in the digital still camera 1 are performed under instructions of the controlling unit 5.

It is to be noted that the imaging unit 2 and the controlling unit 5 correspond to the claimed “imaging part” and “obtaining part”, that the image-processing unit 4 and the controlling unit 5 correspond to the claimed “gradation conversion part”, and that the operating unit 3 and the controlling unit 5 correspond to the claimed “selecting part”.

Next, the image-processing unit 4 will be described below.

As shown in FIG. 1, the image-processing unit 4 includes a white balance adjusting unit 41, an interpolating unit 42, and a gradation conversion unit 43. The digital signal outputted from the A/D converter 23 undergoes white balance adjustment in the white balance adjusting unit 41 and undergoes interpolating processing in the interpolating unit 42. The image data after undergoing the white balance adjustment and the interpolating processing is outputted to the gradation conversion unit 43. The gradation conversion unit 43 is provided with three kinds of tone curves in advance, and the gradation conversion is carried out using a tone curve determined with the method described later. The image data after undergoing the gradation conversion processing is outputted from the image-processing unit 4.

The image-processing unit 4 may include, in addition to the white balance adjusting unit 41, interpolating unit 42, and gradation conversion unit 43 described above, a color correcting unit for performing further image-processing such as color correction. Besides, the white balance adjustment, the interpolating processing, and the gradation conversion are carried out in a manner similar to that in the conventional art.

Next, a description will be made in detail of the alteration of the characteristics of gradation conversion that is one of the characteristics of the present invention.

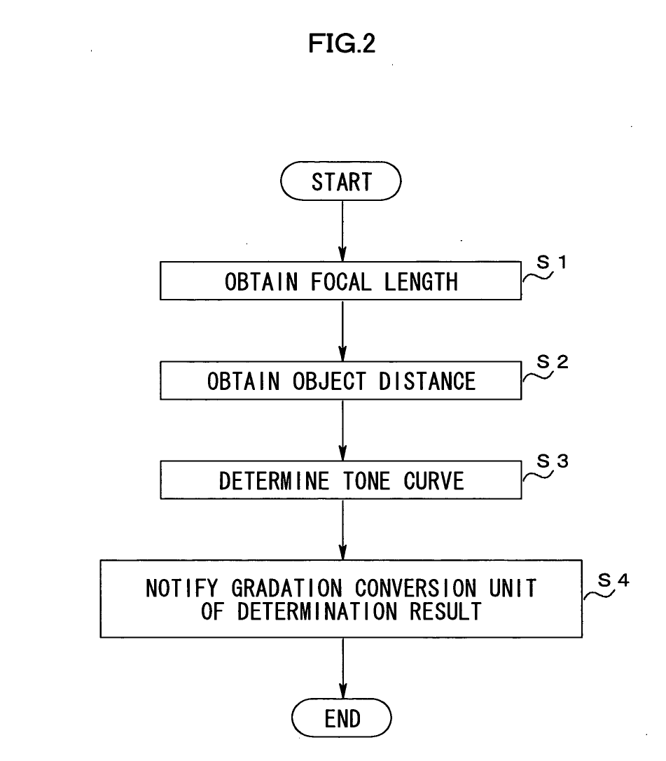

FIG. 2 is a flow chart showing operations of the controlling unit 5 at the time of determining a tone curve.

In step S1, the controlling unit 5 obtains a focal length as subject information.

The controlling unit 5 obtains information indicative of position of the lens group for adjusting the focal length from an encoder (not shown) in the imaging unit 2. Subsequently, the controlling unit 5 determines the focal length based on the information obtained.

In step S2, the controlling unit 5 obtains an object distance as subject information.

The controlling unit 5 obtains information indicative of position of the lens group for focusing from the encoder (not shown) in the imaging unit 2, and determines the object distance based on the information obtained.

In step S3, the controlling unit 5 determines a tone curve with reference to the table.

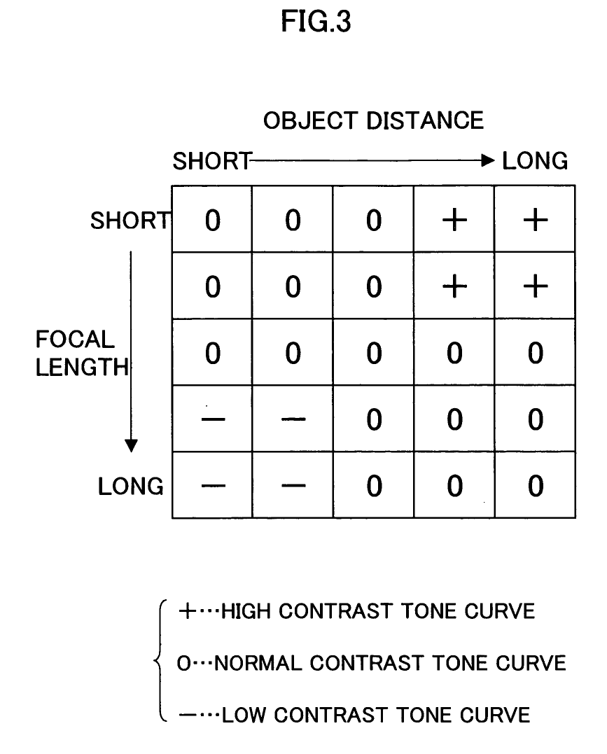

Comparing the focal length and the object distance determined in Steps S1 and S2, respectively, with those of the table shown in FIG. 3, the controlling unit 5 determines which tone curve is used to perform gradation conversion. The table is prepared in advance based on results of the comparison and so on between the focal length and the predetermined reference, and between the object distance and the predetermined reference, and stored in a memory (not shown) in the controlling unit 5.

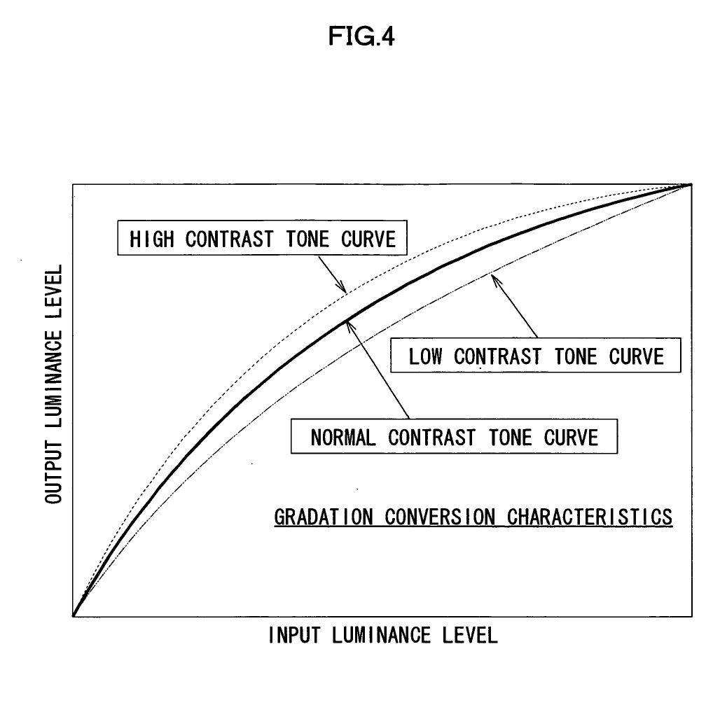

The symbols in the table of FIG. 3 correspond to tone curves differing from one another in characteristic of gradation conversion, respectively. FIG. 4 shows each of the tone curves.

When the focal length is short and the object distance long, a high contrast tone curve is determined as a tone curve for use in the gradation conversion as shown in FIG. 3. Here, a high contrast tone curve corresponds to a characteristic of intensifying a change in gradation within the intermediate range as compared with a normal contrast tone curve (see FIG. 4). The situation where the focal length is short and the object distance long is, for example, a case in which a photograph of a landscape or the like is taken. By carrying out the gradation conversion using the high contrast tone curve, the characteristic of the gradation conversion is altered in such a “direction that the change in gradation becomes more intense”. As such, the change in gradation having been inconspicuous because of the concentration in the intermediate range is enlarged, whereby accentuated image data can be obtained.

Further, when the focal length is long and the object distance is short, a low contrast tone curve is determined as a tone curve for use in the gradation conversion as shown in FIG. 3. A low contrast tone curve corresponds to a characteristic of weakening the change in gradation within the intermediate range as compared with the normal contrast tone curve (see FIG. 4). The situation where the focal length is long and the object distance short is, for example, a case in which a macro-photographing or the like is carried out. By performing the gradation conversion using a low contrast tone curve, the characteristic of the gradation conversion is altered in such a “direction that the change in gradation becomes weaker”. As such, gradation components that were visually inconspicuous due to the tendency of white compression representing loss of gradation in highlight area move toward the intermediate gradation range. At the same time, gradation components that were visually inconspicuous due to the black compression representing loss of gradation in shadow area or the like also move toward the intermediate gradation range. As a result, there is obtained the image data whose gradation expression over the whole screen is visually smooth.

In step S4, the controlling unit 5 notifies the gradation conversion unit 43 of the determination result. That is, the controlling unit 5 notifies the gradation conversion unit 43 of the information as to which tone curve is used to perform gradation conversion. The controlling unit 5 terminates a series of operations after notifying the gradation conversion unit 43 of the determination result.

In the following two cases, the controlling unit 5 carries out operations described below instead of the above-described operations.

First, the operations of the controlling unit 5 in a continuous shooting mode will be described.

A continuous shooting mode is a photographic mode for continuously shooting subject image, and such a mode can be selected by a user via the operating unit 3.

When a user selects a continuous shooting mode, the controlling unit 5 alters the characteristic of the gradation conversion only when the release button is initially pushed, by carrying out the operations in steps S1-S4. Then, from the second time onward, when the release button is pushed, the alteration of characteristic of the gradation conversion is inhibited and the initially determined tone curve is used. This is because, with respect to the image data continuously taken in the continuous shooting mode, more consistent image data can be obtained by using the identical tone curve to perform the gradation conversion.

Next, operations of the controlling unit 5 will be described below where the subsequent photographing is carried out before a predetermined time (for example, three seconds) has elapsed since the beginning of the preceding photographing. In such a case, the controlling unit 5 inhibits the alteration of characteristic of the gradation conversion and uses the tone curve determined at the time of the preceding photographing. This is because such shots taken before the predetermined time has elapsed are regarded as consecutively taken ones despite not in a continuous shooting mode, to obtain consistent image data.

As described above, a tone curve is determined based on a focal length and an object distance, and gradation conversion is performed using the determined tone curve according to this embodiment. This makes it possible to alter the characteristics of gradation conversion depending on a variety of subjects, allowing optimum gradation conversion to be carried out in accordance with a subject.

Specifically, where the focal length is short and the object distance long, the high contrast tone curve is used to perform gradation conversion; on the other hand where the focal length is long and the object distance short, the low contrast tone curve is used to perform gradation conversion; and otherwise the normal contrast tone curve is used to perform gradation conversion. This makes it possible to prevent the generation of non-accentuated image data or image data accompanied by the white compression and/or the black compression, with the result that image data of excellent quality can be obtained.

This embodiment has been described with reference to an example in which the characteristics of gradation conversion are altered based on both the focal length and the object distance. However, the alteration may be carried out based on either one of the focal length and the object distance. For example, where the photo-taking lens is a fixed-focal-length lens (that is, not a zooming lens), the characteristics of gradation conversion are altered depending on the object distance. In this case, it is preferable that when the object distance is long, the high contrast tone curve is determined as a tone curve for use in gradation conversion, thereby altering the characteristic of the gradation conversion in such a “direction that the change in gradation becomes more intense”, whereas when the object distance is short, the low contrast tone curve is determined as a tone curve for use in gradation conversion, thereby altering the characteristic of the gradation conversion in such a “direction that the change in gradation becomes weaker”.

Furthermore, in a case where the characteristics of gradation conversion are altered depending on a focal length, when the focal length is long, the low contrast tone curve is determined as a tone curve for use in gradation conversion, thereby altering the characteristic of the gradation conversion in such a “direction that the change in gradation becomes weaker”, whereas when the focal length is short, the high contrast tone curve is determined as a tone curve for use in gradation conversion, thereby altering the characteristic of the gradation conversion in such a “direction that the change in gradation becomes more intense”.

This embodiment has been described with reference to an example in which the digital still camera 1 has the controlling unit 5 carrying out an automatic focus adjustment based on the information obtained from the image sensor 22. However, any other method for focus adjustment may be employed.

Further, while this embodiment has been described with reference to the so-called autofocus digital still camera 1 which automatically focuses, the so-called manual-focus digital still camera that focuses based on user's operation may be used instead. Further, a digital still camera which is switchable between autofocus and manual-focus is also a possible alternative.

This embodiment has been described with reference to an example in which the photo-taking lens 21 includes a movable lens group for adjusting a focal length and a movable lens group for focusing where the focal length and the object distance are determined based on the positions of the respective lens groups. However, any other method of determining the focal length and the object distance is applicable. For example, in the case of a digital still camera provided with a distance-measuring sensor, the object distance can be determined based on the information obtained by the distance-measuring sensor.

This embodiment has been described with reference to an example in which a tone curve is determined depending on the focal length and the object distance. However, the luminance distribution, the ISO sensitivity (photographic sensitivity), and the existence or absence of light emission from a flash device etc. may be additionally taken into account for determining a tone curve.

For example, where ISO sensitivity is taken into account in addition to the focal length and the object distance, a table as shown in FIG. 3 may be prepared for each ISO sensitivity and kept stored in a memory (not shown) included in the controlling unit 5. Further, a table may be prepared which can select a tone curve depending on the focal length, object distance, and ISO sensitivity, and kept stored in a memory (not shown) included in the controlling unit 5.

This embodiment has been described with reference to an example in which an optimum tone curve is determined out of three kinds of tone curves, that is, a high contrast tone curve, a normal contrast tone curve, and a low contrast tone curve. However, four or more kinds of tone curves may be taken into account for the determination. In such a case, in the table of FIG. 3, it is preferable that as values of the focal length and the object distance get closer to the upper right corner of the table (short focal length and long object distance) or the lower left corner of the table (long focal length and short object distance), the alteration of the tone curves is performed in smaller steps. This is because the effect produced by the alteration of the characteristics of gradation conversion is more enhanced, as the values get closer to the upper right corner or lower left corner of the table.

Further, in this embodiment, luminance information may be obtained continuously in advance. In such a case, when the luminance information exhibits no or little change, the alteration of the characteristics of gradation conversion may be inhibited.

Furthermore, the present invention may be applied to an imaging device other than a digital still camera.

What is claimed is:

1. An imaging device comprising:
an imaging part which picks up a subject image via a photo-taking lens to generate image data;
a gradation conversion part which performs gradation conversion of the image data generated by said imaging part; and
an obtaining part which obtains subject information containing at least one of a focal length of said photo-taking lens and an object distance of the subject, wherein
said gradation conversion part alters a characteristic of the gradation conversion depending on said subject information obtained by said obtaining part when performing the gradation conversion.

2. The imaging device according to claim 1, wherein:
said obtaining part obtains said focal length as said subject information; and
said gradation conversion part alters the characteristic of the gradation conversion in such a “direction that a change in gradation becomes weaker” as said focal length becomes longer than a predetermined reference, and alters the characteristic of the gradation conversion in such a “direction that a change in gradation becomes more intense” as said focal length becomes shorter than said predetermined reference.

3. The imaging device according to claim 1, wherein:
said obtaining part obtains said object distance as said subject information; and
said gradation conversion part alters the characteristic of the gradation conversion in such a “direction that a change in gradation becomes more intense” as said object distance becomes longer than a predetermined reference, and alters the characteristic of the gradation conversion in such a “direction that a change in gradation becomes weaker” as said object distance becomes shorter than said predetermined reference.

4. The imaging device according to claim 1, wherein:
said obtaining part obtains said focal length of said photo-taking lens and said object distance as said subject information; and
said gradation conversion part alters the characteristic of the gradation conversion in such a “direction that a change in gradation becomes more intense” as said focal length becomes shorter and said object distance becomes longer than a predetermined reference, and alters the characteristic of the gradation conversion in such a “direction that a change in gradation becomes weaker” as said focal length becomes longer and said object distance becomes shorter than said predetermined reference.

5. The imaging device according to claim 1, further comprising
a selecting part which selects a continuous shooting mode to continuously take a photograph by means of said imaging part, wherein
said gradation conversion part inhibits the alteration of the characteristic of the gradation conversion on and after the second photographing when said selecting part selects said continuous shooting mode.

6. The imaging device according to claim 1, wherein said gradation conversion part inhibits the alteration of the characteristic of the gradation conversion until a predetermined time has elapsed since the beginning of photographing by said imaging part.
